(19) United States
(12) Patent Application Publication
(10) Pub. No.: US 2011/0025855 A1
(43) Pub. Date: Feb. 3, 2011

(54) DISPLAY DEVICE AND IMAGE OPTIMIZATION METHOD

(75) Inventor: Akihiro Okano, Kanagawa (JP)

Correspondence Address: DRINKER BIDDLE & REATH (DC), 1500 K STREET, N.W., SUITE 1100, WASHINGTON, DC, 20005-1209, US

(73) Assignee: Pioneer Corporation

(21) Appl. No.: 12/934,944

(22) PCT Filed: Mar. 28, 2008
(86) PCT No.: PCT/JP2008/056070

§ 371 Date: Oct. 20, 2010

(51) Int. Cl. H04N 17/02

(52) U.S. Cl. 348/177; 348/E17.004

(57) ABSTRACT

A display device and an image optimization method in which a plurality of features of a received video signal are analyzed, optimization data corresponding to the analyzed result from an optimization information server is acquired when the optimization data is present in the optimization information server, the video signal is corrected on the basis of the optimization data, and a display is driven in accordance with the corrected video signal.

### TECHNICAL FIELD

The present invention relates to a display device having an image optimization function for optimizing an image to be displayed on a display and an image optimization method for the same.

### BACKGROUND ART

To optimize an image displayed on a display of a TV (television) set, a viewer generally adjusts display features of the image such as contrast, brightness, sharpness, color, and hue to desired states by manipulating manipulators such as knobs provided on the TV set. For example, Patent Reference 1 describes an adjustment method in which an image adjustment screen of each display feature is displayed to allow a user to adjust each display feature while viewing a test pattern on the image adjustment screen of the display feature.
Patent Reference 1: Japanese Patent Application Publication No. Heisei 10-177372

### DISCLOSURE OF THE INVENTION

### Problems to be Solved by the Invention

However, this conventional image optimization method has a problem in that optimal image reproduction is not obtained depending on the content of the image since image optimization is not performed taking into consideration the content of the image that the viewer actually views.

Therefore, the present invention has been made in view of, for example, the above problem, and it is an object of the present invention to provide a display device and an image optimization method which can perform image optimization according to the content of an image to be displayed on a display.

### Means for Solving the Problems

In accordance with an aspect of the present invention, the above and other objects can be accomplished by the provision of a display device having an image optimization function for optimizing an image to be displayed on a display, the display device comprising: analysis means for analyzing a plurality of features of a supplied video signal; data acquisition means for acquiring optimization data corresponding to a result of the analysis by the analysis means from an optimization information server when the optimization data is present in the optimization information server; correction means for correcting the video signal based on the optimization data acquired by the data acquisition means; and drive means for driving the display in accordance with the video signal corrected by the correction means.

In accordance with another aspect of the present invention, there is provided an image optimization method for optimizing an image to be displayed on a display, the method comprising the steps of: analyzing a plurality of features of a supplied video signal; acquiring optimization data corresponding to a result of the analysis in the analyzing step from an optimization information server when the optimization data is present in the optimization information server; correcting the video signal based on the optimization data acquired in the acquiring step; and driving the display in accordance with the video signal corrected in the correction step.

### BEST MODE FOR CARRYING OUT THE INVENTION

In the display device of the invention according to claim 1 and the image optimization method of the invention according to claim 8, when a plurality of features of a supplied video signal is analyzed, the analyzed result represents the content such as category of an image to be displayed on the display. Therefore, it is possible to perform image optimization according to the content of the image to be displayed on the display by acquiring optimization data corresponding to the analyzed result from the optimization information server and correcting the video signal based on the acquired optimization data.

### BRIEF DESCRIPTION OF THE DRAWINGS

FIG. 1 is a block diagram of an embodiment of the present invention;

FIG. 2 is a flow chart illustrating an optimization operation; and

FIG. 3 is a flow chart illustrating a continued part of the optimization operation of FIG. 2.

### DESCRIPTION OF REFERENCE NUMERALS

1: disk player
2: TV set
17: display panel
31: optimization information server
35: network

### EMBODIMENTS

Embodiments of the present invention will now be described in detail with reference to the drawings.

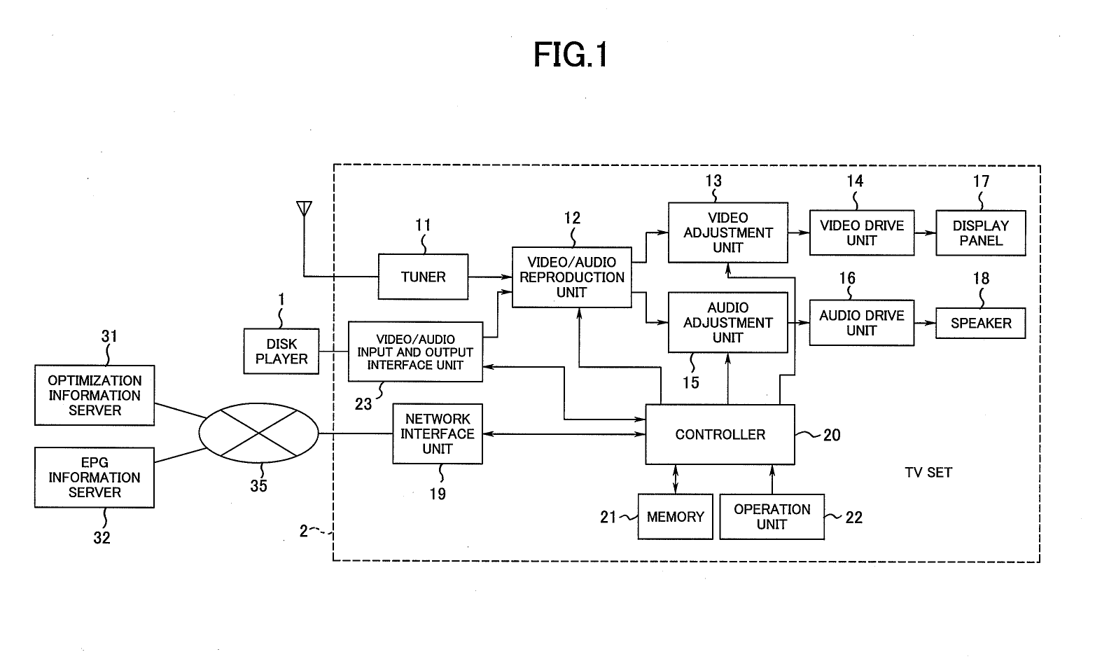

FIG. 1 illustrates a video/audio reproduction system to which the present invention is applied. The video/audio reproduction system includes a disk player 1, which is a peripheral device, and a TV set 2 which is a display device.

The disk player 1 plays a loaded disk such as a Blu-ray disc to generate a video signal, an audio signal, and a control signal.

The TV set 2 includes a tuner 11, a video/audio reproduction unit 12, a video adjustment unit 13, a video drive unit 14, an audio adjustment unit 15, an audio drive unit 16, a display panel 17, a speaker 18, a network interface unit 19, a controller 20, a memory 21, an operation unit 22, and a video/audio category interface unit 23.

The tuner 11 receives a television broadcast signal of a channel selected according to an instruction from the controller 20 and outputs the received broadcast signal to the video/audio reproduction unit 12. The video/audio reproduction unit 12 performs a reproduction process, including decoding using a decoder (not shown), on the broadcast signal received through the tuner 11 to generate digital or analog video and audio signals and provides the video and audio signals to the video adjustment unit 13. The audio signal output from the video/audio reproduction unit 12 is provided to the audio adjustment unit 15.

The video adjustment unit 13 has image correction functions including an image quality correction function, a noise reduction (NR) function, and an interlaced to progressive image (IP) conversion function, which are controlled by the controller 20. The video adjustment unit 13 corrects a video signal output from the video/audio reproduction unit 12 or from the disk player 1 through the image correction functions and provides the corrected video signal to the video drive unit 14. The video drive unit 14 drives the display panel 17 in accordance with the corrected video signal output from the video adjustment unit 13 and displays an image represented by the video signal on a display surface of the display panel 17.

The audio adjustment unit 15 has an equalizer function for sound quality correction and corrects an audio signal output from the video/audio reproduction unit 12 or from the disk player 1 and provides the corrected audio signal to the audio drive unit 16. The audio drive unit 16 drives the speaker 18 in accordance with the corrected audio signal output from the audio adjustment unit 15 to cause the speaker 18 to generate sound corresponding to the audio signal.

The network interface unit 19 accesses an external information server such as an optimization information server 31 or an electronic program guide (EPG) information server 32 through a network 35 to receive reproduction setting information data or EPG data.

The controller 20 includes, for example, a microcomputer, and acquires information data such as EPG data included in a television broadcast signal from the tuner 11 and also acquires information data such as reproduction setting information from the network interface unit 19. The memory 21 stores information data.

The controller 20 controls the operation of each component of the TV set 2. In addition, the controller 20 performs image quality optimization by controlling each function of the video adjustment unit 13 as described above and performs sound quality optimization by controlling the equalizer function of the audio adjustment unit 15 as described above.

The controller 20 is connected to the disk player 1 through the video/audio category interface unit 23. A control signal output from the disk player 1 is provided to the controller 20 through the video/audio category interface unit 23 and a control signal output from the controller 20 is also provided to the disk player 1 through the video/audio category interface unit 23.

The video/audio category interface unit 23 provides a video signal and an audio signal output from the disk player 1 to the video/audio reproduction unit 12. The video/audio reproduction unit 12 performs a reproduction process on a video signal and an audio signal from the video/audio category interface unit 23 and provides the resulting video signal to the video adjustment unit 13 and the resulting audio signal to the audio adjustment unit 15. The video/audio category interface unit 23 has, for example, an HDMI interface function.

The operation unit 22 provides the controller 20 with a variety of instructions such as an external input instruction or a channel selection instruction in accordance with user manipulation. Although not illustrated, the operation unit 22 includes a remote control transceiver enabling remote control.

When a disk is loaded in the disk player 1 in the video/audio reproduction system constructed as described above, disk information is read from the disk. The read disk information is, for example, a disk number of the disk. The read disk information is provided to the controller 20.

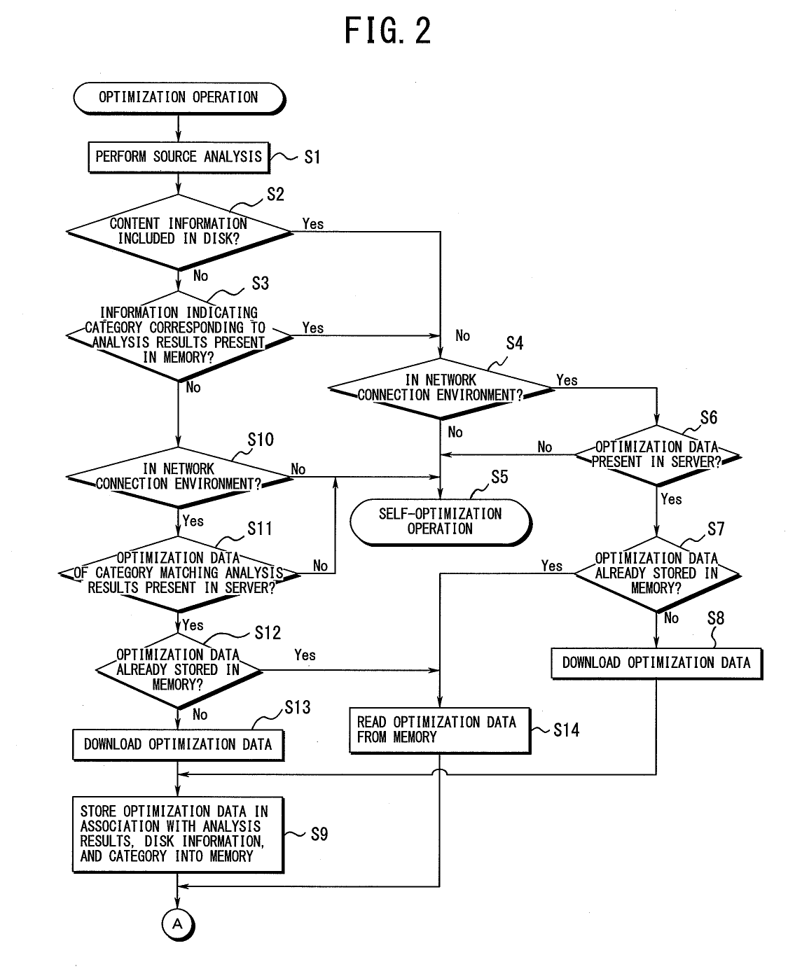

When the disk information is provided to the controller 20, the controller 20 starts an optimization operation. In the optimization operation, first, the controller 20 performs source analysis as shown in FIG. 2 (step S1). Source analysis is performed on a video signal and an audio signal recorded on the disk loaded in the disk player 1. Specifically, image analysis (for example, image pattern recognition, histogram analysis, scene change analysis, or object analysis) is performed on the video signal and audio analysis is performed on the audio signal. A result of the image analysis includes (1) a peak white level, an average white level, and a bottom white level, (2) a flesh color-dominant area, (3) a screen motion vector, (4) a color histogram, (5) a peak SN value, an average SN value, and a bottom SN value, (6) a composition detection, (7) presence or absence of subtitles, presence or absence of a time indication, and telop detection, and (8) black bar detection. A result of the audio analysis includes (1) a reproduction frequency, (2) audio distortion, and (3) audio delay.

After performing source analysis of step S1, the controller 20 determines whether or not content information is included in the disk (step S2). The content information is information indicating a category, a title, and the like of content represented by a source recorded on the disk. The category is, for example, news, sports, movie, or drama.

When the content information is not included in the disk, the controller 20 determines whether or not information indicating the category corresponding to the results of the source analysis of step S1 is stored in the memory 21 (step S3). Since optimization data of analysis results, category, disk information, and reproduction information (video and audio) is stored in the memory 21 as described later, the controller 20 compares corresponding information stored in the memory 21 with the analysis results to detect a category, for which the degree of similarity between the stored information and the analysis results is greater than a threshold value and is also the greatest among all categories.

Upon determining that content information is included in the disk in step S2 or determining that information representing the category is stored in the memory 21 in step S3, the controller 20 determines whether or not the system is in a network connection environment (step S4). That is, in this embodiment, the controller 20 determines whether or not the system is in an environment in which it is connectable to the optimization information server 31. When the system is not in a network connection environment, the controller 20 performs a self-optimization operation (step S5). In the self-optimization operation, when the category has been determined, the controller 20 sets respective adjustment levels of the video adjustment unit 13 and the audio adjustment unit 15 so that the results of the source analysis (i.e., image analysis and audio analysis) described above have values determined according to the category.

Upon determining in step S4 that the system is in a network connection environment, the controller 20 accesses the optimization information server 31 to determine whether or not optimization data corresponding to the disk information or optimization data corresponding to the category is present in the optimization information server 31 (step S6). When the optimization data is not present, the controller 20 performs the above step S5. When the optimization data is present, the controller 20 determines whether or not the optimization data is already stored in the memory 21 (step S7). When the optimization data is already stored in the memory 21, the controller 20 reads the optimization data from the memory 21 (step S14). The controller 20 downloads the optimization data from the optimization information server when the optimization data is not stored in the memory 21 and also downloads the optimization data from the optimization information server if it is newer than optimization data stored in the memory 21 even when the stored optimization data corresponds to the same disk information or the same category (step S8) and stores the downloaded optimization data in the memory 21 in association with the disk information, category, and analysis results (step S9).

On the other hand, upon determining in step S3 that information indicating the category is not stored in the memory 21, the controller 20 determines whether or not the system is in a network connection environment (step S10). This determination is similar to that of step S4. Upon determining in step S10 that the system is not in a network connection environment, the controller 20 proceeds to step S5 to perform a self-optimization operation. In this self-optimization operation, since the category has not been determined, the controller 20 sets respective adjustment levels of the video adjustment unit 13 and the audio adjustment unit 15 so that the results of the source analysis described above have default values.

Upon determining in step S10 that the system is in a network connection environment, the controller 20 accesses the optimization information server 31 to determine whether or not optimization data of a category matching the results of the source analysis is present in the optimization information server 31 (step S11). Since source analysis data is stored for each category in the optimization information server 31, the controller 20 compares the source analysis results of step S1 with corresponding information of the source analysis data of each category to detect a category, for which the degree of similarity between the source analysis results and the source analysis data is greater than a threshold value and is also the greatest among all categories. When the category has been detected in this manner, the controller 20 determines that optimization data corresponding to the category is present. Upon determining that optimization data of the matching category is present, the controller 20 determines whether or not the optimization data is already stored in the memory 21 (step S12). This determination is similar to that of the above step S7. When the optimization data is already stored in the memory 21, the controller 20 reads the optimization data from the memory 21 (step S14). When the optimization data is not stored in the memory 21, the controller 20 downloads the optimization data (step S13) and stores the downloaded optimization data in the memory 21 in association with the disk information, category, and analysis results (step S9). Upon determining in step S11 that the optimization data is not present, the controller 20 performs the above step S5.

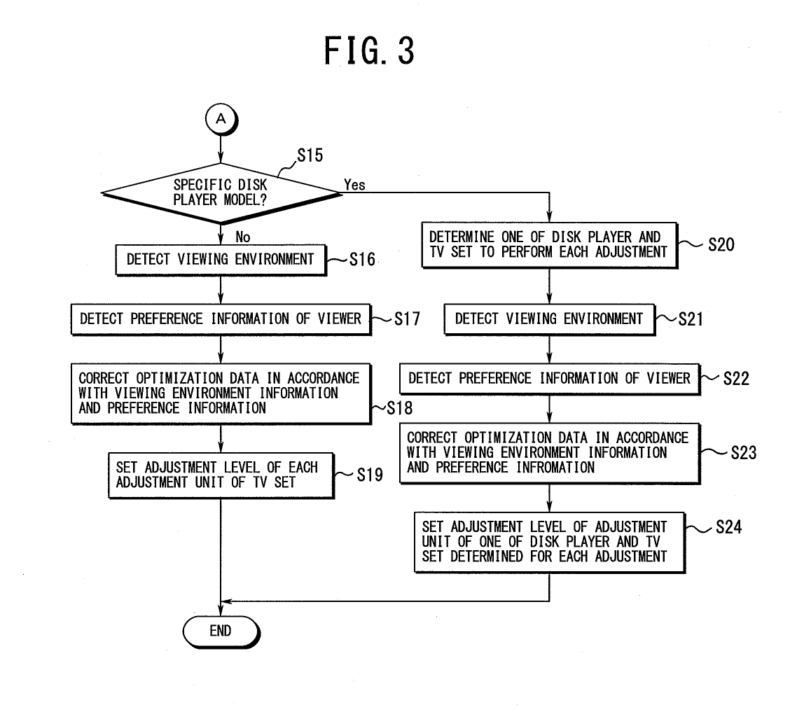

After performing step S9 or S14, the controller 20 determines whether or not the disk player 1 is a specific model as shown in FIG. 3 (step S15). Here, the specific model is a disk player model of the same manufacturer as the TV set 2. When the disk player 1 is not of the specific model, the controller 20 detects a viewing environment of a viewer who is a user of the TV set 2 (step S16). The viewing environment is, for example, a distance between the TV set 2 and the viewer which the TV set 2 measures by receiving a signal emitted by a remote controller (not shown) that is manipulated by the viewer of the TV set 2. The viewing environment may be the size of a space such as a room or a place such as a house or a vehicle, in which the TV set 2 is installed, or another condition of the space such as brightness. The viewer may previously input information regarding the viewing space through the operation unit 22 to store the information and thereafter the stored information may be read in step S16. The controller 20 reads preference information of the viewer after detecting the viewing space (step S17). The viewer may also previously input the preference information of the viewer through the operation unit 22 to store the preference information and thereafter the stored preference information may be read in step S17.

The controller 20 corrects optimization data in accordance with the information of the viewing space and the preference information of the viewer obtained in steps S16 and S17 (step S18) and sets respective adjustment levels of the video adjustment unit 13 and the audio adjustment unit 15 in accordance with the corrected optimization data (step S19). Accordingly, for example, the controller 20 performs setting of respective adjustment levels of contrast, brightness, and RGB balance of the video adjustment unit 13 and performs setting of a sound quality adjustment level in the equalizer of the audio adjustment unit 15.

When the disk player 1 is the specific model, the controller 20 determines, in accordance with the model, one of the disk player 1 and the TV set 2 which is to perform adjustment of each of the NR, IP conversion, and image quality correction functions (step S20). Both the disk player 1 and the TV set 2 have the NR, IP conversion, and image quality correction functions. Therefore, for each of the NR, IP conversion, and image quality correction functions, the controller 20 selects the one of the disk player 1 and the TV set 2 that exhibits better performance for the function as a device which will perform the function. For example, the controller 20 selects the disk player 1 for the NR function if the performance of the NR function of the disk player 1 is better than that of the TV set 2. On the other hand, the controller 20 selects the TV set 2 for the IP conversion function if the performance of the IP conversion function of the TV set 2 is higher than that of the disk player 1.

After performing step S20, the controller 20 detects the viewing space of the TV set 2 (step S21) and also detects preference information of the viewer (step S22). The controller 20 then corrects optimization data in accordance with the information of the viewing space and the preference information of the viewer obtained in steps S21 and S22 (step S23) and adjusts the disk player 1 or the TV set 2 for each function in accordance with the corrected optimization data (step S24). For each of the image quality and sound quality adjustment functions, the controller 20 adjusts the one of the disk player 1 and the TV set 2 which has been selected in step S20. For example, when the disk player 1 has been selected for the NR function, the controller 20 sets the adjustment level of an NR adjustment unit (not shown) in the disk player 1 in accordance with the corrected optimization data. In addition, when the TV set 2 has been selected for the IP conversion function, the controller 20 sets the adjustment level of an IP conversion adjustment unit (not shown) in the TV set 2 in accordance with the corrected optimization data. The controller 20 controls the adjustment unit of the disk player 1 via the video/audio category interface unit 23.

As is apparent from the above description, in the above embodiment, when source analysis is performed on a video signal and an audio signal received from the disk player 1, the analyzed results represent the content such as a category of an image to be displayed on the display. Therefore, it is possible to perform image optimization according to the content of the image to be displayed on the display by acquiring optimization data corresponding to the analyzed results from the optimization information server and correcting the video signal and the audio signal based on the acquired optimization data.

Although the above embodiment has been described with reference to an example wherein an optimization operation is performed when a disk loaded in the disk player 1 is played, it is also possible to perform an optimization operation on broadcast programs received through the tuner 11 of the TV set 2 by performing source analysis on each program in the same manner as when the disk is played. The present invention is especially effective in a region in which EPG data of the broadcast programs is not available.

In addition, the viewing environment may include conditions such as season, data and time, temperature, or the number of viewers in addition to the conditions described above.

Further, a panel such as a Plasma Display Panel (PDP), an LCD panel, or an OLED panel may also be used as the display panel.

Furthermore, although the above embodiment has been described with reference to an example wherein the controller in the TV set performs source analysis, the present invention is not limited to this example and a device such as a PC externally connected to the TV set may also be allowed to perform source analysis.

1. A display device having an image optimization function for optimizing an image to be displayed on a display, the display device comprising:
an analysis portion which analyzes a plurality of features of a supplied video signal;
a data acquisition portion which acquires optimization data corresponding to a result of the analysis by the analysis portion from an optimization information server when the optimization data is present in the optimization information server;
a correction portion which corrects the video signal based on the optimization data acquired by the data acquisition portion;
and
a driver which drives the display in accordance with the video signal corrected by the correction portion,
wherein the correction portion includes:
a viewing environment detection portion which detects a viewing environment of the display device; and
a preference detection portion which detects preference information of a viewer of the display device, and
wherein the correction portion corrects the video signal in accordance with the optimization data acquired by the data acquisition portion, the viewing environment detected by the viewing environment detection portion, and the preference information detected by the preference detection portion.

2. The display device according to claim 1, wherein the data acquisition portion includes:
a memory in which analysis data regarding a video signal of each category is already stored;
a category determination portion which determines whether or not a category corresponding to analysis data similar to the analysis result by the analysis portion is present in the memory;
a category identification portion which identifies, when a category corresponding to analysis data similar to the analysis result by the analysis portion is present in the memory, the corresponding category as a category of content represented by the video signal;
a download portion which downloads, when optimization data regarding the category identified by the category identification portion is present in the optimization information server, the optimization data from the optimization information server; and
a request portion which requests the optimization information server to determine, when a category corresponding to analysis data similar to the analysis result by the analysis portion is not present in the memory, whether or not optimization data regarding the category corresponding to the analysis data similar to the analysis result by the analysis portion is present in the optimization information server, and
wherein, when optimization data regarding the category corresponding to the analysis data similar to the analysis result by the analysis portion is present in the optimization information server, the optimization information server supplies the optimization data to the data acquisition portion.

3. The display device according to claim 2, wherein the download portion includes:
a portion which writes the downloaded optimization data into the memory in association with a category; and
a portion which determines, when optimization data regarding the category identified by the category identification portion is present in the optimization information server, whether or not the present optimization data is newer than the optimization data written into the memory, and
wherein the download portion downloads the optimization data from the optimization information server when the optimization data present in the optimization information server is newer than the optimization data written into the memory and reads the optimization data regarding the identified category from the memory when the optimization data present in the optimization information server is not newer than the optimization data written into the memory.

4. The display device according to claim 1, wherein, when a medium number specifying a recording medium in which the video signal is stored is acquired from a player that plays the recording medium, the data acquisition portion acquires optimization data from the optimization information server corresponding to the medium number.

5. (canceled)

6. The display device according to claim 1, further comprising a determination portion which determines whether or not a peripheral device, which is connected to the display device and generates the video signal, is a specific model,
wherein, when the peripheral device is the specific model, the correction portion uses one of respective video signal correction functions provided in the peripheral device and the display device, the one having higher performance than the other.

7. The display device according to claim 1, wherein the analysis portion analyzes a plurality of features of an audio signal supplied together with the video signal,
the correction portion corrects the video signal and the audio signal in accordance with the optimization data acquired by the data acquisition means, the viewing environment detected by the viewing environment detection portion, and the preference information detected by the preference detection portion, and
the driver drives a speaker in accordance with the audio signal corrected by the correction portion.

8. An image optimization method in a display device for optimizing an image to be displayed on a display, the method comprising the steps of:
analyzing a plurality of features of a supplied video signal;
acquiring optimization data corresponding to a result of the analysis in the analyzing step from an optimization information server when the optimization data is present in the optimization information server;
detecting a viewing environment of the display device;
detecting preference information of a viewer of the display device;
correcting the video signal in accordance with the optimization data acquired in the acquiring step, the viewing environment detected in the viewing environment detecting step, and the preference information detected in the preference detecting step; and
driving the display in accordance with the video signal corrected in the correction step.
